(19) United States
(12) Patent Application Publication
(10) Pub. No.: US 2024/0317087 A1
(43) Pub. Date: Sep. 26, 2024

(54) TRANSFORMERLESS ON-BOARD CHARGING DEVICE FOR ELECTRIC VEHICLES, AND METHOD FOR CONTROLLING A DC-DC STAGE IN A TRANSFORMERLESS ON-BOARD CHARGING DEVICE FOR ELECTRIC VEHICLES

(71) Applicant: UNIVERSITÄT PADERBORN, Paderborn (DE)

(72) Inventor: Frank SCHAFMEISTER, Soest (DE)

(21) Appl. No.: 18/574,198

(22) PCT Filed: Jun. 22, 2022
(86) PCT No.: PCT/EP2022/067070

§ 371 Date: Dec. 26, 2023

(30) Foreign Application Priority Data
Jul. 2, 2021 (DE) 10 2021 206 982.7

(51) Int. Cl. B60L 53/22; H02M 1/00; H02M 1/42

(52) U.S. Cl. CPC B60L 53/22; H02M 1/007; H02M 1/4233; B60L 2210/12; B60L 2210/14

(57) ABSTRACT

The disclosure relates to a transformerless on-board charging device for electric vehicles for the low-leakage current charging of a traction battery BAT having a first DC-DC stage and a second DC-DC stage, where the two DC-DC stages are connected in series as a double stage, where the first DC-DC stage and the second DC-DC stage each have
at least two switching elements, in particular one transistor and one diode or two transistors,
at least one inductor coil, and
at least one output capacitor.

Furthermore, the disclosure relates to an associated method for controlling a DC-DC stage in a transformerless on-board charging device for electric vehicles.

The invention relates to a transformerless on-board charging device for electric vehicles and method for controlling a DC-DC stage in a transformerless on-board charging device for electric vehicles.

### BACKGROUND

The traction batteries of electric cars, particularly all-electric battery-powered vehicles (EVs) must be charged at high power levels from the generally available alternating current (AC) grid to shorten charging times and increase the acceptance of EVs.

High power levels (e.g., 10 kW and up, particularly 11 kW, 22 kW, etc.) are achieved primarily by means of three-phase (in the EU region) or single-/two-phase (also referred to as “split-phase” in North America) on-board chargers (OBCs) installed in the EV.

The input stage of such an OBC is formed by a grid-friendly pulse rectifier (PFC: Power Form corrector), while a DC-DC converter, as the output stage, achieves the connection to the traction battery.

Recently, there has been a tendency to design the OBC without a potential-separating power transformer since this essentially results in decreased cost, weight and electricity losses when in operation.

These decreases become even more noticeable in regenerative, bidirectional OBCs, which are required for so-called vehicle-to-grid (V2G) functionality, for example.

Omitting the transformer also entails a few technical challenges, however, that are currently hardly resolved in a way that is suitable for everyday use.

By selecting suitable PFC ground circuits, high-frequency pulsating battery potential can be prevented despite omission of a transformer, but depending on the PFC circuit and especially the form of the AC supply grid (typically the US split-phase grid), there will be a low-frequency pulsating battery potential, which results in interfering and impermissible leakage currents.

These low-frequency leakage currents (50-150 Hz) can and must generally be compensated for in an active manner.

To this end, work is currently being done on traditional, dedicated additional compensation circuits (primarily in industrial research and development), which are connected upstream of the OBC.

The applicant has already performed research in this field in the past. In this research, designs were developed (German patent 102020214265.3 or international patent application PCT/EP2021/081496, German patent application DE102019129754.0, or international patent application PCT/DE2020/100377) relating to new transformerless PFC topologies that were characterized by low-common-mode or common-mode-free output voltages, for example.

In particular, it should be noted that German patent application 102020214265.3 and international patent application PCT/EP2021/081496 do enable single-phase charging designed for emergency use on a European supply grid, in which one can select the intermediate circuit capacitance to be small. However, it is only in this single-phase operation on the European grid, i.e., with the neutral conductor then connected to the capacitive intermediate circuit midpoint, that a first intermediate circuit partial voltage during a fully positive grid half-period and a second intermediate circuit partial voltage during a fully negative grid half-period switches through solely to the battery, whereby one DC-DC stage is pulsed in at a high frequency and the other DC-DC stage is switched off, in each case alternating with a fixed grid frequency.

However, these topologies are only common-mode-free, i.e., especially also without low-frequency leakage currents, when they are not connected, for example, with the objective of achieving a similar power yield on the North American single-phase split phase grid. If this is done, however, there remains a low-frequency pulsating (60 Hz in the US split phase) potential portion on both battery terminals, which then causes a corresponding leakage current.

### BRIEF DESCRIPTION OF THE INVENTION

Within the scope of the invention, however, a new DC-DC stage subsequent to this type of or another PFC topology and its operating method will now be described.

### BRIEF DESCRIPTION OF THE DRAWINGS

The invention is explained in greater detail below by means of a drawing and embodiments. The illustrations are schematic representations and are not to scale. The illustrations do not restrict the invention in any way.

FIGS. 1A-1C show an overview diagram regarding the reason for the invention,

FIG. 2 shows an arrangement with an embodiment of the invention when connected to a three-phase grid,

FIG. 3 shows a similar arrangement with an embodiment of the invention when connected to a split-phase grid,

FIG. 4 shows a simulation generated using SIMPLORER in relation to FIG. 3,

FIG. 5 shows another arrangement with an embodiment of the invention when connected to a split-phase grid,

FIG. 6A-D show curves for the circuit of FIG. 5 with a symmetrical load of the DC-DC stages,

FIG. 7A-D show curves for the circuit of FIG. 5 with an alternating load of the DC-DC stages according to the invention,

FIG. 8 shows an additional aspect according to embodiments of the invention,

FIG. 9 shows a depiction of a sample voltage level when operating on a US split-phase grid in embodiments of the invention,

FIG. 10 shows various illustrative designs of switching elements for use within the scope of the invention, and

FIG. 11 shows a schematic illustration of the control principle in embodiments of the invention.

### DETAILED DESCRIPTION OF THE INVENTION

The invention will be described in greater detail below with reference to the drawings. It should be noted that various aspects are described which can be used individually or in combination. This means that any given aspect can be used with various embodiments of the invention as long as it is not explicitly represented as a mere alternative.

Also, for simplicity's sake and as a rule, reference will always be made below to only one entity. However, unless noted otherwise, the invention may in each case also have several of the entities in question. To that extent, the use of the words “a” and “an” are to be understood only as an indication that at least one entity is being used in a single embodiment.

To the extent that methods are described hereinafter, the individual steps of a method can be arranged and/or combined in any sequence as long as said combination does not explicitly yield a diverging result. Furthermore, the methods can be combined with one another unless expressly indicated otherwise.

To the extent that this application mentions standards, specifications or the like, reference shall be made at least to the standards, specifications or the like that were applicable on the filing date. In other words, if a standard/specification and so on is updated or replaced by a subsequent one, then the invention shall also be applicable to this.

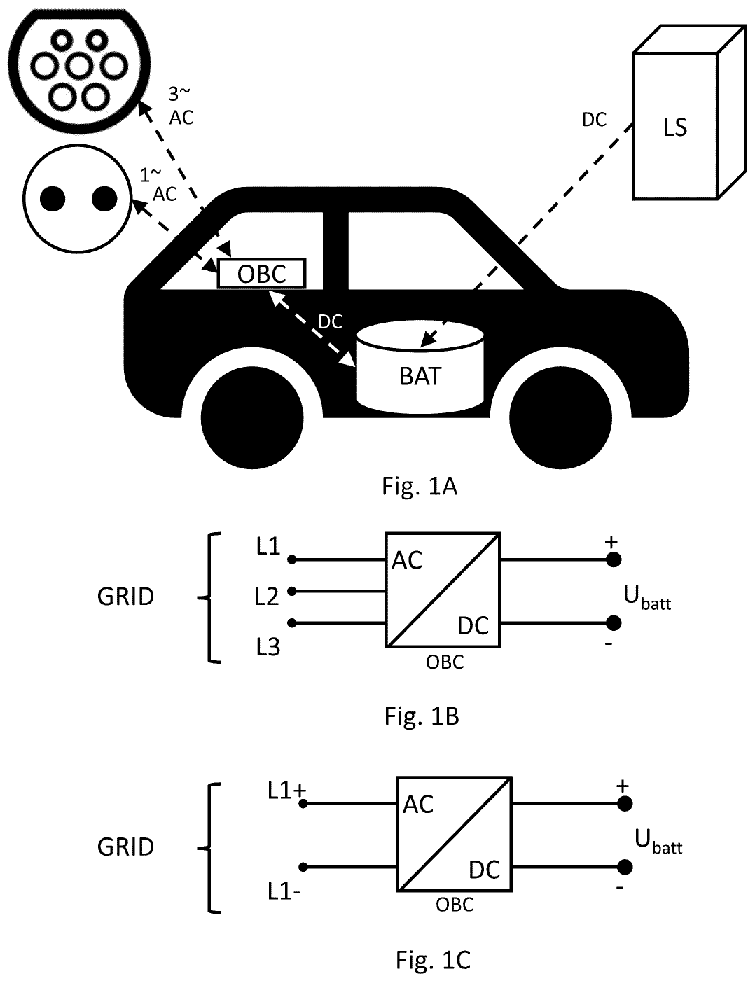

FIG. 1A depicts a typical charging situation for a (electric) vehicle having a rechargeable battery BAT. Typically, the battery BAT can be recharged by a direct current source, such as a charging station LS, or the battery BAT can obtain alternating current AC from a GRID using an on-board charger (OBC) and convert it into direct current DC. Various grid configurations are conceivable or known. Most common in Europe is a three-phase power supply with 120-degree offset phases L1, L2, L3, as shown in FIG. 1B. In North America, most common currently in residential areas is the so-called split-phase power supply, in which two opposite phases (each offset by 180°) are provided.

In principle, it would be advantageous to provide devices that enable one to charge the battery BAT from various grid topologies, particularly from the European three-phase and the US split-phase grids, with little effort and low cost-both in regard to production as well as operation—while keeping the weight low.

Within the scope of the invention, it may also be provided that the devices of the invention are used to release electrical energy from the battery BAT back to an alternating current grid or an alternating current load (vehicle-to-grid and vehicle-to-load, respectively).

The approach of the present invention is to compensate for the previously-described undesired leakage disturbance currents using the already present DC-DC stages of the OBC. These can stabilize the otherwise pulsating battery potential by a suitable control process (with almost no change in the dimensions) and keep it more or less constant so that practically no or significantly fewer leakage currents are caused by (parasitic) battery capacitances, or explicit filter capacitances of the high-voltage on-board network, to vehicle ground.

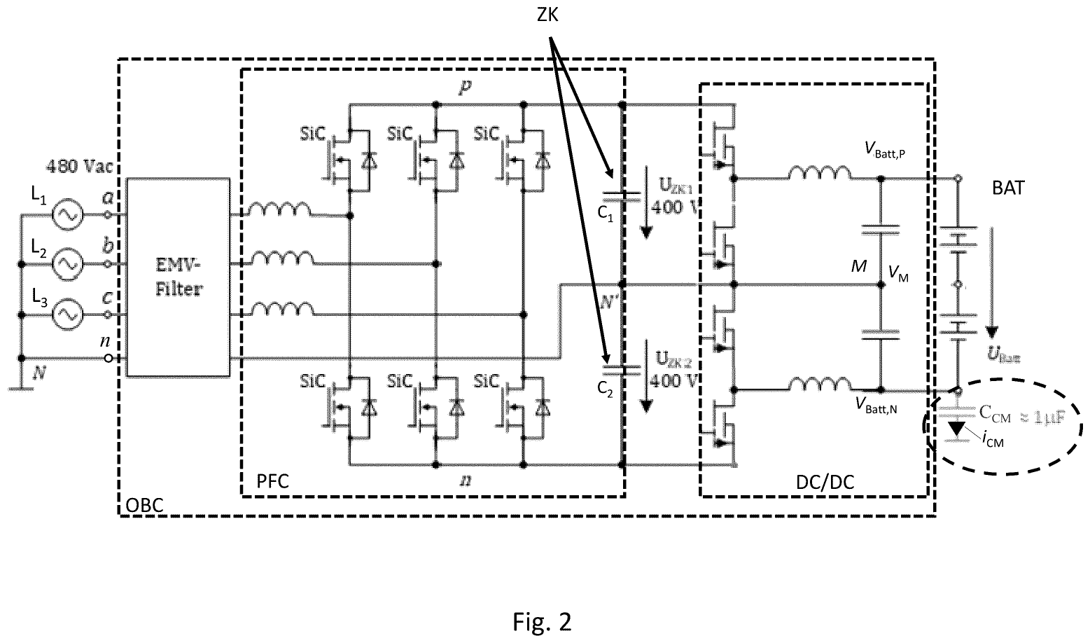

Such an arrangement is shown in FIG. 2, which depicts a transformerless OBC. On the one hand, it has an illustrative PFC circuit (which can be replaced by other circuits), an intermediate circuit ZK, a DC-DC stage arrangement relating to the invention, as well as an illustrative (parasitic) leakage current or leakage capacitance (which is indicated by the oval figure). This illustrative capacitance represents, for example, the relatively high parasitic electrical capacitance, provided by the large-scale traction battery, of the battery terminals in relation to the vehicle ground. This can take on significant values in the μF range (asymmetrically represented-obviously, there may also be a similar (parasitic) leakage capacitance to the positive potential V_{Batt,p} of the battery).

In this arrangement, a B6-PFC stage with a symmetrical DC-DC double-stage is used against the midpoint of the capacitive voltage distributor of the intermediate circuit N′. By means of this arrangement, the negative battery potential V_{Batt,n} (as well as the positive potential V_{Batt,p}) and thus the leakage current i_{CM} through C_{CM} can be adjusted via the DC-DC stage. The same applies when the potential V_{M} of the midpoint M, connected to N′, of the intermediate circuit ZK oscillates at a low frequency (typically 50-150 Hz), e.g., because N′ is applied to the negative conductor L1-oscillating at 60 Hz in the interest of achieving a high power output when operating in a US split-phase grid. In this otherwise critical situation as well, the battery potentials V_{Batt,p} and V_{Batt,n} can be kept (almost) constant (“compensated”) according to the invention using the symmetrical DC-DC double stage. In this way, the interfering leakage current i_{CM} is ideally prevented by means of the parasitic capacitance C_{CM} (since i_{CM}=C_{CM} dV_{Batt,n}/dt), or reduced in a truly significant manner.

The higher the battery voltages are, which are currently trending toward 800 V, the better the compensation (almost complete) that can be achieved at higher potential amplitudes of N′.

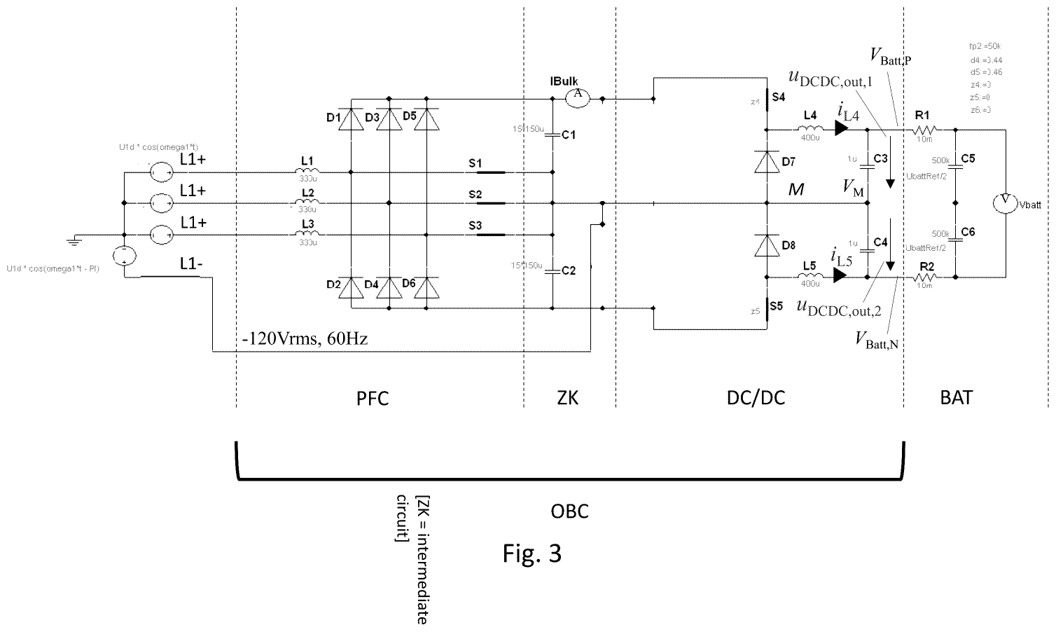

FIG. 3 depicts an illustrative interface connection to a split-phase grid. L1+ is connected to the first three connection terminals (a,b,c) of the OBC and L1− is connected to the fourth grid connection terminal (n). In a conventional DC-DC stage and/or operating mode, there would be a high leakage current in this configuration.

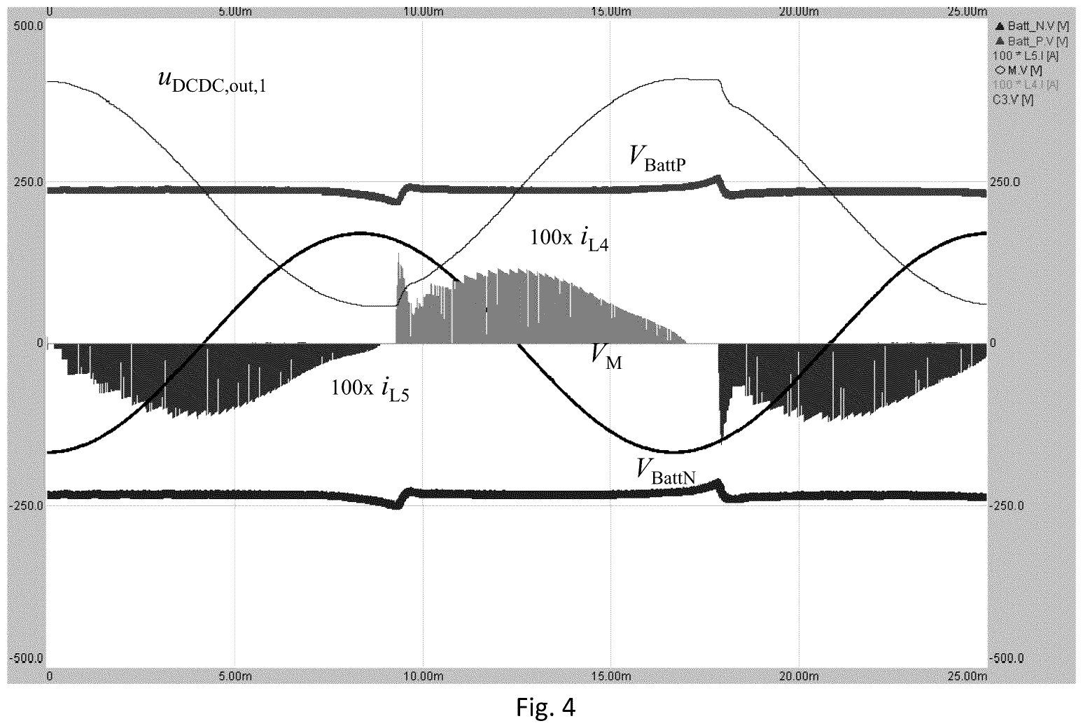

By contrast, FIG. 4 documents the operation according to the invention for the arrangement per FIG. 3. With a grid voltage of +/−120 V_{RMS} at 60 Hz, the potential at point M results in an amplitude of \hat{V}_{M}=\sqrt{2} 120 V=170 V; however, given a battery voltage of U_{Batt}=470 V for the potentials at the battery terminals of BAT at V_{BattP}=235 V and V_{BattN}=−235 V, symmetrical and constant values are set. A DC-DC output capacitance of C_{3/4}=1 μF results in a moderate charge reversal current of approximately Î_{L4/L5}≈1A and, according to the invention, a DC-DC output voltage pulsating in opposition to the medium potential V_{M} of u_{C3}=58 . . . 410V (in a symmetry-corresponding manner, u_{C4}=−410 . . . 58V). In other words, in such an operating mode as shown in FIG. 4, the medium potential V_{M} oscillates at a frequency and amplitude of the split-phase conductor L1− (e.g., 60 Hz); however, the battery terminal potentials V_{BattP} and V_{BattN}, accessible to the leakage capacitance, are kept practically constant by the DC-DC stages (dV_{Batt,P}/dt≈0, dV_{Batt,N}/dt≈0) controlling the output voltage according to the invention. Thus, effectively zero (or at least very little) leakage current i_{CM}=C_{CM} dV_{Batt,N}/dt is produced.

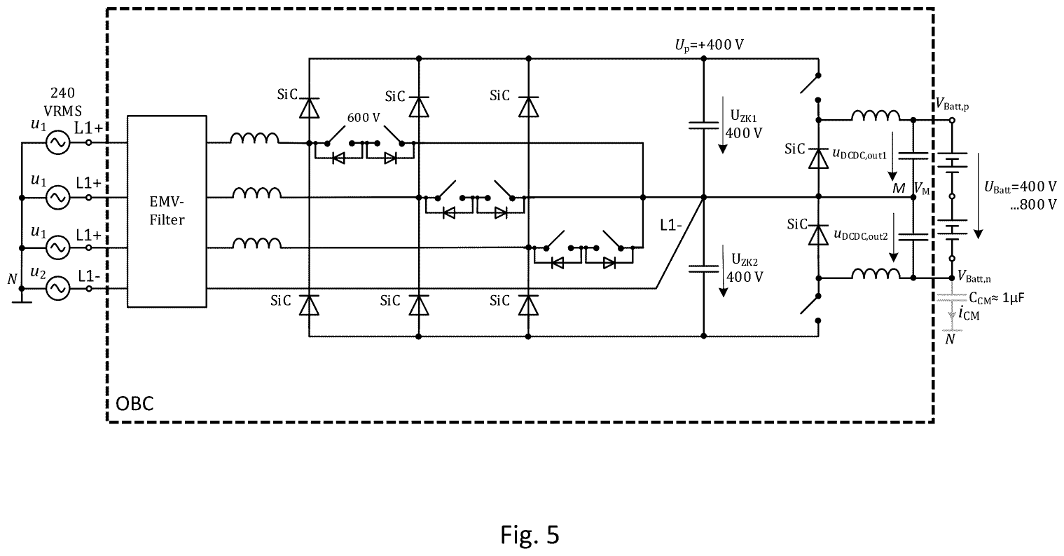

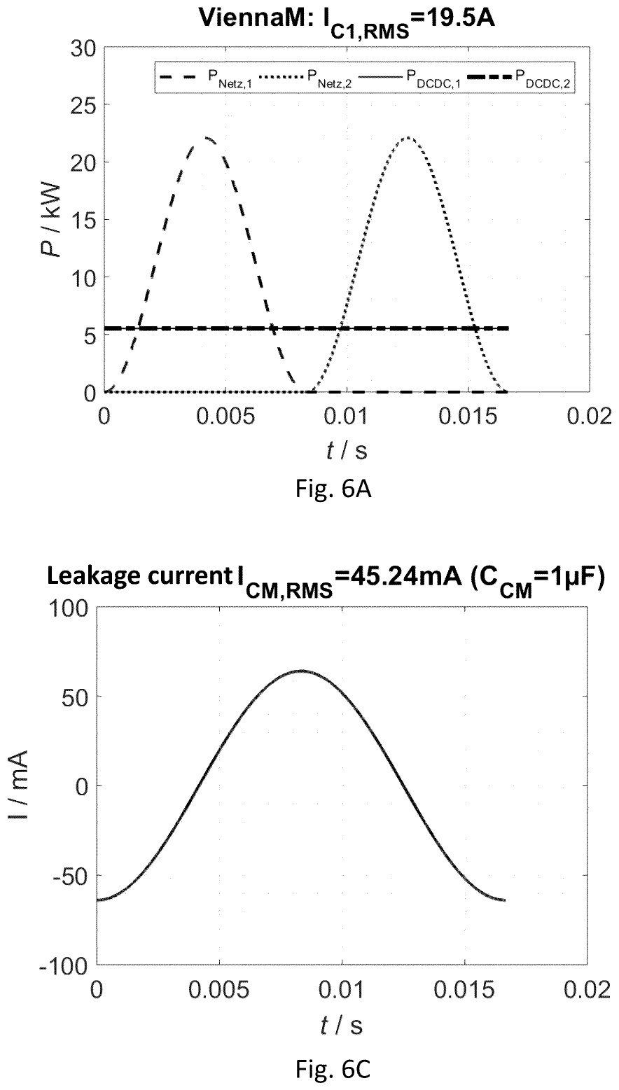

FIG. 5 considers a variant of the Vienna rectifier PFCs (cf. PCT/DE2020/100377, hereinafter referred to as ViennaM) on a US split-phase grid, for which 120 V_{RMS} at 60 Hz is once again assumed. FIGS. 6A-D and 7A-D are to be viewed in relation to this circuit. The connection to the grid is similar to the one shown in FIG. 3, i.e., L1− can be considered a voltage signal that is inverted or phase-shifted by 180° in relation to L1+.

In FIGS. 6A-D, for a voltage curve over time of \sqrt{2} 120 V sin (ωt), the result is a leakage current I_{CM,RMS}=120 V·2π·60 Hz·1 μF=45 mA. The reason is that conventionally P_{DCDC,1}=P_{DCDC,2} is controlled, from which it follows that for U_{Batt}=400 V (assumed), μ_{DCDC,out,1}=μ_{DCDC,out,2}=200 V=const. The constant output voltages of the DC-DC stages result in a 60-Hz fluctuation of the battery terminal potential V_{BattN} (V_{BattP} also), since the medium potential V_{M} also fluctuates. Thus, the leakage current calculated above is generated with the grid frequency (i.e., in this case 60 Hz) (cf. FIG. 6C).

However, if—as proposed according to the invention—the battery terminal potentials V_{BattP} and V_{BattN} are set to a constant target value ±U_{Batt}/2, time-variable DC-DC output voltages μ_{DCDC,out,1}=U_{Batt}−μ_{DCDC,out,2} as well as outputs of the DC-DC sub-stages p_{DCDC,1} and p_{DCDC,2}, which vary over a grid period, will result. This advantageously results in a very low leakage current of I_{CM,RMS}<0.65 mA.

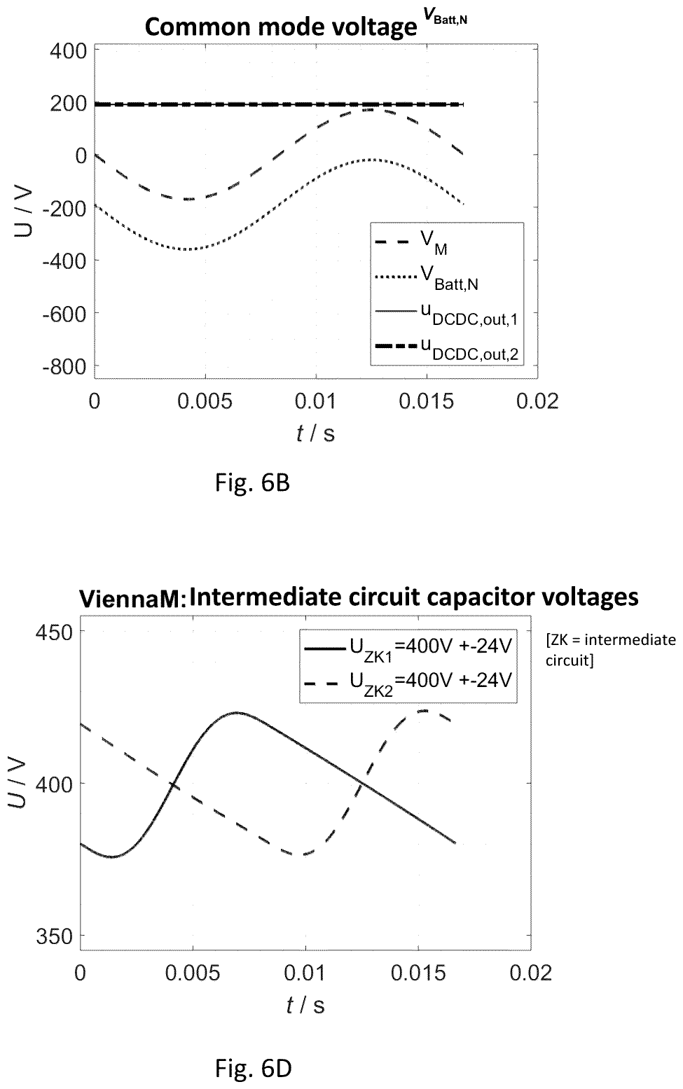

The corresponding output curves, voltages and leakage currents can be seen in FIGS. 7A-D. The outputs of the DC-DC substages are no longer constant, although the total output over both substages is. Since the load varies over time (periodically at approximately 50-150 Hz), there is no thermally relevant overload of the DC-DC substages.

Assuming a battery voltage of U_{Batt}=400 V and an OBC charging output of 11 kW, the result is P_{DCDC,1,2}=5.5 kW±4.8 kW·sin(ωt). It should be noted that the periodic portion (in this case 4.8 kW) depends on the battery voltage U_{Batt}.

Provided that \hat{V}_{M}<U_{Batt}/2, one can fully compensate for the leakage current.

In addition, the voltage fluctuation (ripple) at the intermediate circuit capacitors of the OBC can be significantly reduced; cf. comparison of FIG. 7A to 6A. The voltage change at the capacitors thereby also drops and the current load of the intermediate circuit capacitors I_{C,RMS} also decreases. This results in the capacitance requirement in the intermediate circuit decreasing when operated according to the invention in a split-phase grid, whereby costs and installation space can be reduced.

In the illustrative calculation regarding the previously mentioned values, one is able to achieve a reduction of 36% in relation to ΔU_{ZK1/2}, i.e., 36% less capacitance requirement on the US split-phase grid, and one can also decrease the current load I_{C,RMS} by 32%.

Given a reverse polarity of conductors (L₁ or L₂ or L₃) and neutral conductor (N) in the European 400/230 V grid and the then (unintended) achieved connection of the conductor to the medium potential (\hat{V}_{M}=\sqrt{2} 230 V=325 V), the resulting leakage current can only be fully compensated for U_{Batt}≥650 V=2 \hat{V}_{M}; however, this is largely fulfilled given an expected increase of the nominal battery voltage to 800 V.

In this context, it shall also be noted that a non-complete, partial compensation of the low-frequency oscillating battery terminal potentials appears to be a worthwhile measure. According to i_{CM}=C_{CM} dV_{Batt,n}/dt, the interfering leakage currents for a given capacitance C_{CM} are determined by the rate of change over time (slope dV_{Batt,n}/dt and dV_{Batt,p}/dt) of the battery potentials. For these typical sine-shaped, grid-frequency timelines of the observed potentials, the rate of change is greatest especially at the zero-crossing. In other words, even if the potentials V_{Batt,p} and V_{Batt,n} can be compensated and kept constant only for the zero-crossing of the medium potential V_{M} for a very small battery voltage U_{Batt}, the effect in terms of decreasing the leakage current is greatest precisely at this location. Thus, the remaining residual leakage current will in any event have a notably smaller effective value. These residual currents can then be further decreased as needed with conventional additional compensation stages. The dynamics- and output-related requirements on the latter are thus reduced.

Besides using the inherent DC-DC stages, an advantage of the arrangement and method according to the invention is especially the fact that the measurement and control concept appears simpler and more robust than the complex and error-prone additional compensation circuits as conventionally developed, particularly since these must still differentiate between the mentioned leakage currents and safety-related fault currents (which may not be compensated).

The efficiency of the proposed method also does not appear to be any less than that of the conventional compensation circuits mentioned above.

An additional advantage of the method is that depending on the grid type, the modified control of the DC-DC stages can also result in a savings in intermediate circuit capacitance, i.e., typically of voluminous electrolyte capacitors.

The present invention allows for an inherent compensation of low-frequency leakage currents without any additional compensation effort.

In this way, operating a transformerless OBC on the US split-phase network is also made possible. Furthermore, the invention also enables the international use of OBCs on a wide variety of AC grids.

The invention is based on the simple, robust regulation of the inherent DC-DC stages and, by decreasing the leakage currents, it can also significantly improve the EMC behavior of a transformerless OBC.

In addition, the invention allows a savings in capacitance in the intermediate circuit.

The invention presented here can thus also compensate the low-frequency common mode voltage at the battery terminals (e.g., approximately 150 Hz) remaining in the PFC topologies of the German patent application DE 102020214265.3.

In particular, the invention can also compensate the low-frequency common-mode voltage at the battery terminals (e.g., approximately 60 Hz), which results from the operation of other three-phase PFC stages (e.g., six-switch full bridge (B6) with an intermediate circuit midpoint connection or Vienna rectifier with an intermediate circuit midpoint connection (ViennaM; see for example patent publication WO 2020/233 741 A1) on the US split-phase grid (i.e., when conductor L1− is applied to the n-terminal of the OBC)).

This inherent “straightforward” compensation via the DC-DC stages of device 1 can take place by means of a relatively simple and robust regulation of said stages.

By contrast, work is conventionally being done on active, dedicated compensation stages, which first measure low-frequency leakage currents, and must separate a fault current portion of it as needed, to then attempt to compensate the regular leakage current portion by means of an opposite current input (or opposite common mode voltage input) (with the then possible dynamics).

The invention relates in particular to a transformerless on-board charger for electric vehicles for the low leakage current charging of a traction battery BAT having a first DC-DC stage and a second DC-DC stage, wherein the two DC-DC stages are connected in series as a double stage on the intermediate circuit side, i.e., both substages, each consisting of at least two switching elements (transistor and diode, or transistor and transistor), at least one inductor coil and at least one output capacitor, are arranged symmetrically in relation to the capacitive midpoint of the intermediate circuit. In this way, each DC-DC stage is connected to a sub-intermediate circuit. On the battery side, the two DC-DC stages are also connected in series and connected to the same capacitive midpoint of the intermediate circuit side. Both DC-DC stages are set up to generate a time-variable output voltage when in operation by means of simultaneous switching, wherein the (variable) frequency lies between the grid frequency and three times the grid frequency. In other words, the frequency of the output voltage to be generated typically lies between the grid frequency and three times the grid frequency. Generally, the battery has only two connections and is connected to the two external terminals of the output capacitors of the two DC-DC stages.

In an advantageous design, both of the at least two switching elements of the individual DC-DC stages are designed as transistors. In this case, each DC-DC stage can conduct currents in both directions (bidirectionally) from and to the intermediate circuit; see for example FIG. 2.

In an advantageous design, the outer switching element of the at least two switching elements of the individual DC-DC stage is designed as a transistor and the internal switching element of the at least two switching elements is designed as a diode. In this case, each DC-DC stage can carry only currents from the intermediate circuit to the battery side (unidirectionally); see for example FIGS. 3 and 5.

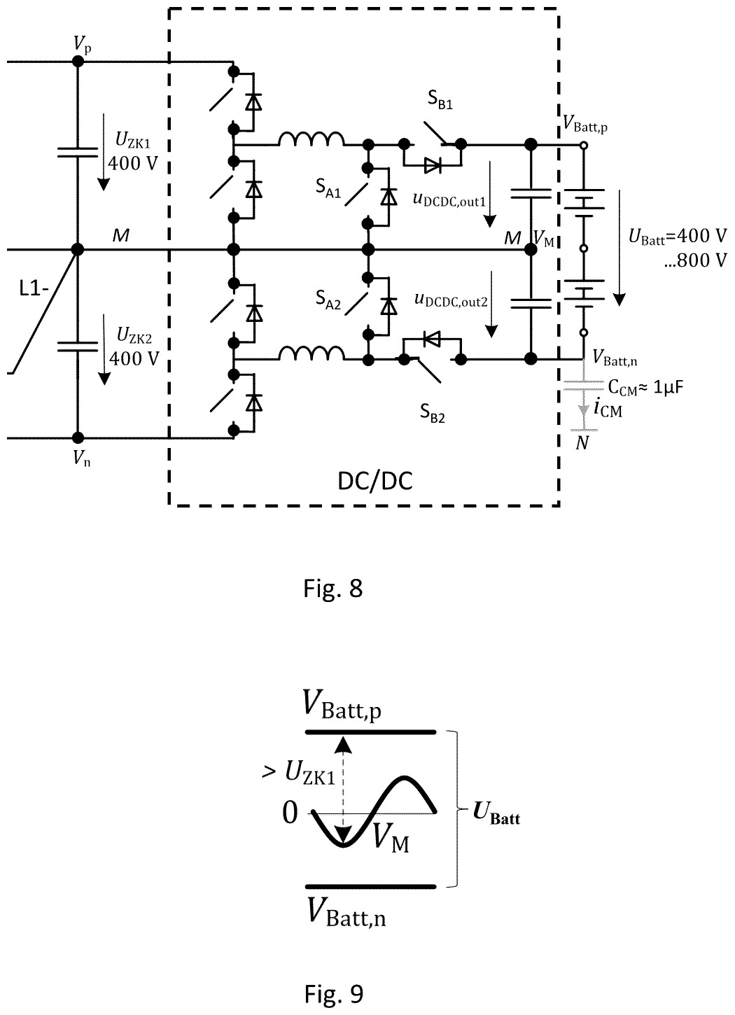

In an advantageous design, the transistor switching elements are implemented as GaN-based (gallium nitride-based) transistors; see also FIG. 10.

In an advantageous design, the transistor switching elements are implemented as SiC-based (silicon carbide-based) MOS field effect transistors (MOSFET); see also FIG. 10.

In an advantageous design, the transistor switching elements are implemented as Si-based (silicon-based) MOS field effect transistors (MOSFET) or as SiC-based (silicon carbide-based) MOS field effect transistors (MOSFET) or as GaN-based (gallium nitride-based) high-electron mobility transistors (HEMT) or as Si-based (silicon-based) insulated gate bipolar transistors (IGBT); see also FIG. 10.

In an advantageous design, both DC-DC stages generate a time-variable output voltage, whose frequency typically lies between the grid frequency and three times the grid frequency, e.g., in the magnitude of the grid frequency (typically 50-150 Hz).

In an advantageous design, at least one of the two DC-DC stages adjusts the phase angle of its time-variable output voltage in such a manner that it is in antiphase with the low-frequency oscillating medium potential (V_{M}), wherein the (variable) frequency of the time-variable output voltage is between the grid frequency and three times the grid frequency, e.g., in the magnitude of the grid frequency (typically 50-150 Hz). In other words, one of the two DC-DC stages sets the phase angle of its time-variable output voltage in such a manner that it is in antiphase with the low-frequency (typically, the grid frequency to three times the grid frequency) fluctuating medium potential (V_{M}).

In an advantageous design, at least one of the two DC-DC stages sets the amplitude of its time-variable output voltage in such a manner that it corresponds to the amplitude of the low-frequency oscillating medium potential (V_{M}) and thus ensures a constant battery terminal potential (V_{Batt,p} and/or V_{Batt,n}), wherein the (variable) frequency of the time-variable output voltage lies between the grid frequency and three times the grid frequency, e.g., in the magnitude of the grid frequency (typically 50-150 Hz). In other words, one of the two DC-DC stages sets the amplitude of its time-variable output voltage in such a manner that it corresponds to the amplitude of the low-frequency (typically, the grid frequency to three times the grid frequency) fluctuating medium potential (V_{M}), and thus ensures a constant battery terminal potential (V_{Batt,p} and/or V_{Batt,n}).

In an advantageous design, a controller provides the matching, time-variable output voltage of at least one of the DC-DC stages and thereby inherently ensures at least a constant battery terminal potential (V_{Batt,p} and/or V_{Batt,n}).

In an advantageous design, a controller is set up in a cascade structure and regulates the battery terminal potential V_{Batt,p} and/or V_{Batt,n} to a constant target value in the superordinate control circuit. The time-variable inductive current of the respective DC-DC current is controlled in the subordinate control circuit.

In an advantageous design, the voltage measurement of the respective battery terminal potential of the superordinate control circuit uses the neutral conductor, or the protective earth (PE), which is available in the charging plug and in the vehicle-side charging socket as a signal contact, as the reference potential.

It shall be noted that the drawings do show a step-down function. However, the invention is not restricted to this. Instead a step-up function can be provided by arranging switching elements downstream from the inductors.

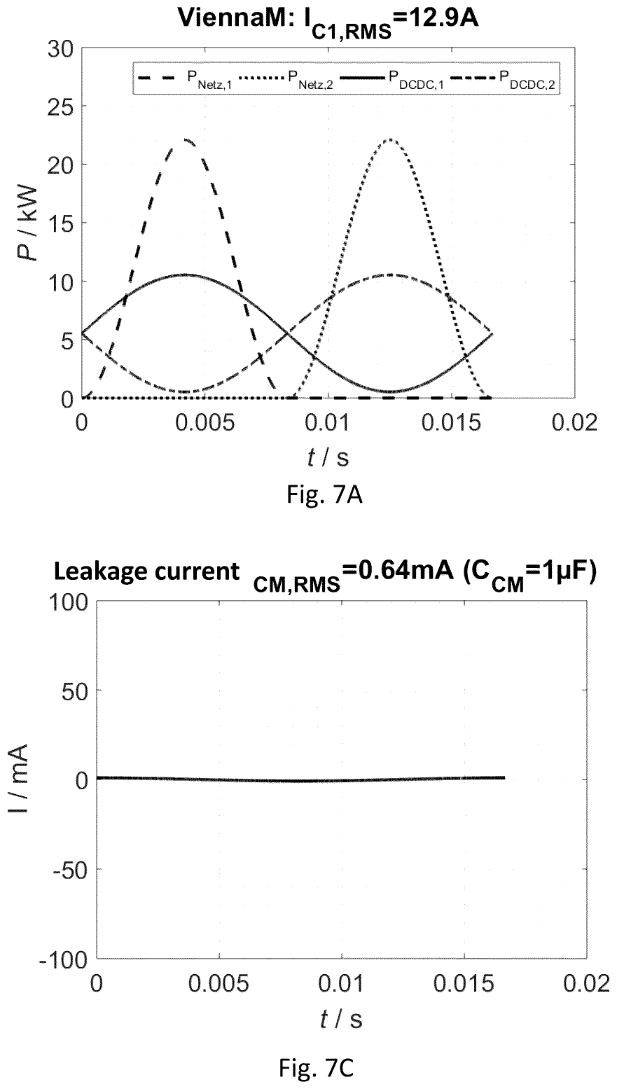

According to another aspect of the invention (see FIG. 8), there may be provided between each inductor coil and output capacitor of the DC-DC stages an additional switch device S_{A1}, S_{B1}, and S_{A2}, S_{B2} to the capacitive midpoint of the intermediate circuit and to the external connection of the respective output capacitor. S_{B1}, S_{B2} can thereby be designed as diodes if a unidirectional current flow (from the intermediate circuit to the battery) is sufficient for the charging operation. Should the charging device be designed in a manner to have feed-in capability (vehicle-to-grid, vehicle-to-load applications), a bidirectional current flow is required and S_{B1}, S_{B2} are to be designed as transistors (as depicted in FIG. 8).

By means of the identified additional switch devices S_{A1}, S_{B1}, and S_{A2}, S_{B2}, the existing DC-DC stages are supplemented by a step-up function so that the entire DC-DC stage now has a step-down/step-up function (buck-boost), while the designs without these additional switch devices S_{A1}, S_{B1}, and S_{A2}, S_{B2} on the right side of the inductor coils essentially only provide a step-down function.

The step-up function is particularly advantageous when the battery voltages take on high values, e.g., U_{Batt}=800 V. The intermediate circuit voltage U_{ZK1/2}, as the input voltage of the DC-DC stages, is practically limited upward, e.g., to U_{ZK1}+U_{ZK2}=450 V+450 V=900 V. The challenge now is operation on the US split-phase grid (i.e., when US conductor L1− is connected to the n-terminal of the OBC). Then, the medium potential V_{M} of the OBC corresponds to the potential of the conductor L1− and fluctuates at a grid frequency and amplitude V_{M,ampl}=√2·120 V=170 V of the mains conductor.

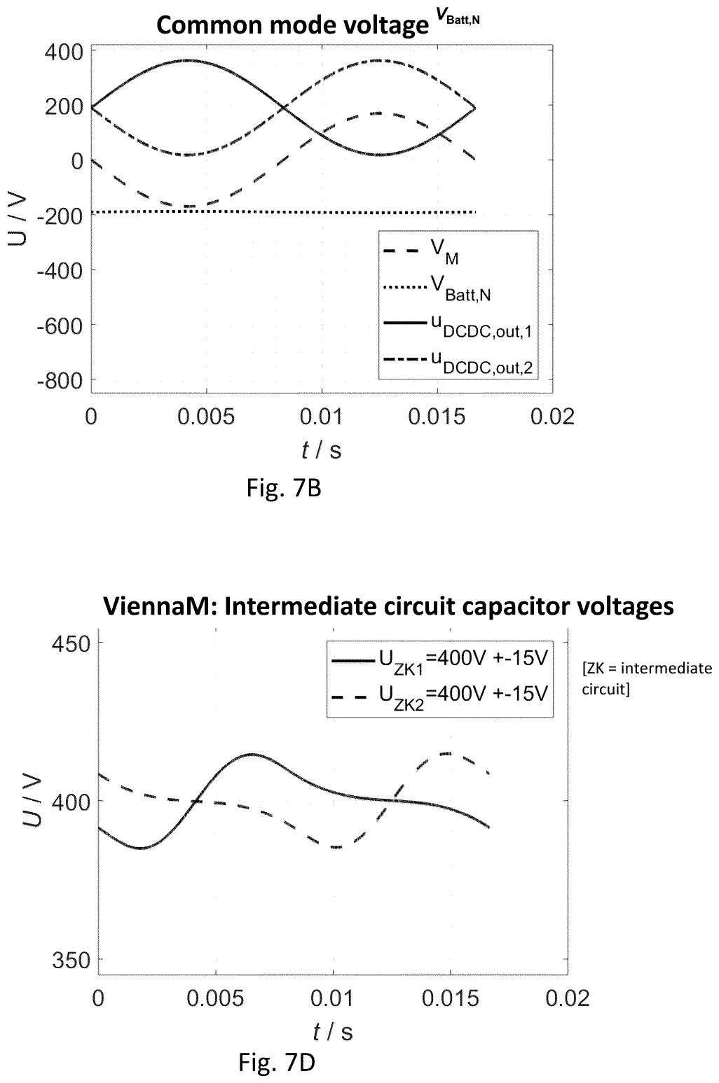

To allow one to keep the battery potential V_{Batt,p} at a high level (e.g., +400 V), according to FIG. 9 the first DC-DC stage would then generate in a worst-case scenario (peak demand) an output voltage of u_{DCDC,out1}=V_{M,ampl}+V_{Batt,p}=V_{M,ampl}+U_{Batt}/2=170 V+800 V/2=570 V, wherein however only an input voltage of U_{ZK1}=450 V is provided at the DC-DC stage. This applies similarly for the second DC-DC stage. By means of the step-up function of the additional switch devices S_{A1}, S_{B1} and S_{A2}, S_{B2}, the output voltage of each DC-DC stage, which is higher in relation to the input voltage, can now be provided. Therefore, with the step-up function, the following now applies to the positive battery potential: V_{Batt,p}>U_{ZK1}−V_{M,ampl}. This applies similarly for the negative battery potential: V_{Batt,n}<−U_{ZK2}+V_{M,ampl}. Since the battery voltage generally results in U_{Batt}=V_{Batt,p}−V_{Batt,n}, the aforementioned relationships can also be expressed by the battery voltage: U_{Batt}, >2 (U_{ZK1}−V_{M,ampl}). Without the step-up function, complete compensation of the low-frequency common mode voltages (and currents, see below) would therefore only be possible for battery voltages up to U_{Batt}, ≤2 (U_{ZK1}−V_{M,ampl}).

Typical grid frequencies are, for example, 16 2/3 Hz, 50 Hz, 60 Hz as well as in the range of 200 Hz-400 Hz.

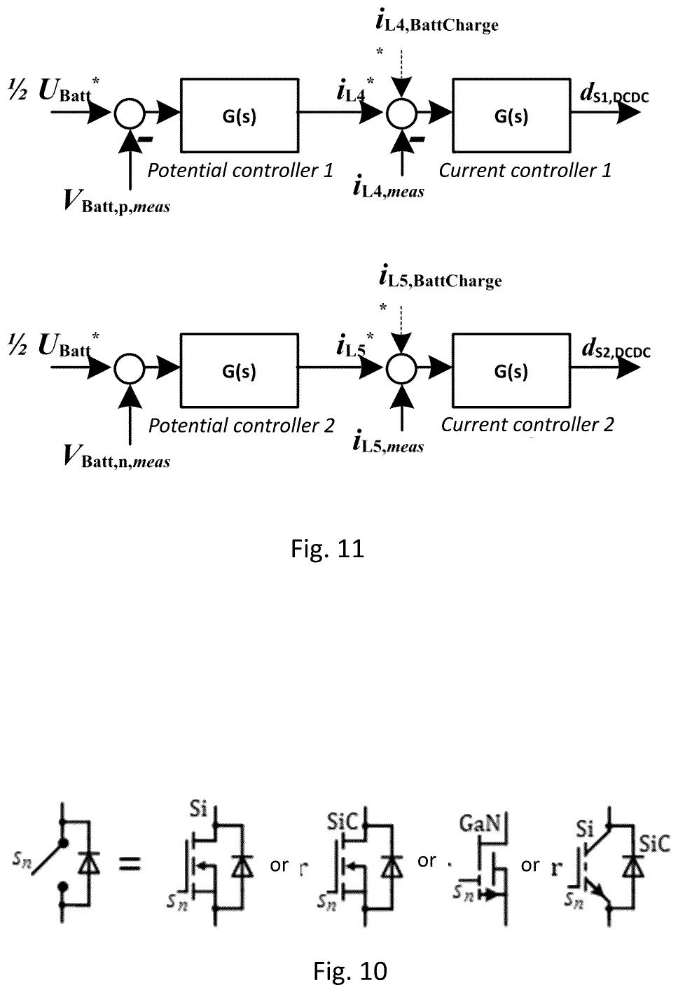

FIG. 11 depicts an illustrative control circuit according to the embodiments of the invention. According to the invention, two independent, respectively cascaded control circuits with superordinate battery potential control and subordinate inductor coil control are provided for the at least two DC-DC stages.

The control value of the superordinate potential controller here is the respective terminal potential of the traction battery V_{Batt,p} (positive potential, e.g., +200 V) or V_{Batt,n} (negative potential, e.g., −200 V), which is measured in each case against the neutral potential N (0V) of the power supply network.

It should be noted that, in the vehicle-side charging socket for US split-phase operation, the neutral potential N can be provided as a signal contact, which can be used by high-ohm voltage measurement circuits as a reference value for measuring the battery terminal potential. (However, a power connection for the neutral potential N is not available there.) The target value for the potential controller is in each case half the target value of the battery voltage U_{Batt} (cf. also FIG. 8).

The control value of the subordinate current controller is the respective inductive current (i_{L4} or i_{L5}) of the DC-DC stages, which must be set with the correct polarity and consists in each case of a grid-frequency alternating component for the charge reversal of the output capacitors (C₃ and C₄, respectively; cf. FIG. 8), as well as a largely constant battery charging current component. The target value of the battery charging current component (i_{L4,BattCharge}* or i_{L5,Battcharge}*) can optionally (e.g., by increasing the dynamics) also be added up separately by a pilot control measure at the input of the current controller.

In each case, the subordinate current controllers emit, according to a suitable limiting measure as needed, the duty cycles for the transistors of the DC-DC stages. These duty cycles are converted, for example, by pulse width modulation (PWM), taking into account the specified switching frequency into the switch signals for the respective transistors.

Lastly, it should be noted that the (additional) switching elements according to the invention may be designed differently. Illustrative embodiments are shown in FIG. 10, without being limited to these, however. Illustrative depicted embodiments are, for example, a (silicon) MOSFET or a (SiC) MOSFET or a (GaN) HEMT or a (silicon) IGBT with (SiC) diodes. It should be noted that in each of the first three examples, a diode is intrinsically connected to the transistor.

The invention differs in its embodiments from prior art particularly through its symmetrical DC-DC stage in relation to the reference point M, said stage being controlled in such a manner that the respective battery potentials V_{Batt,p} and V_{Batt,n} are kept (essentially) constant. In other words, no noteworthy low-frequency current i_{CM}=C_{CM} dV_{Batt,n}/dt arises (see FIG. 7c). In other words, low-frequency common-mode currents or voltages are already compensated by the DC-DC stage so that additional specific compensation devices can be omitted.

The invention differs in particular from prior art in that when it comes to providing the charging function, no electrical connection is required between the midpoint of the batteries and the midpoint potential of the DC-DC stage.

What is claimed is:

1. Transformerless on-board charging device for electric vehicles for the low-leakage-current charging of a traction battery BAT having a first DC-DC stage and a second DC-DC stage, wherein the two DC-DC stages are connected in series as a double stage, wherein the first DC-DC stage and the second DC-DC stage each have
at least two switching elements, in particular one transistor and one diode or two transistors,
at least one inductor coil, and
at least one output capacitor,
wherein both the first DC-DC stage as well as the second DC-DC stage are arranged symmetrically to a capacitive midpoint of an intermediate circuit, wherein in each case a DC-DC stage is connected to a partial intermediate circuit, wherein on the battery side the two DC-DC stages are connected in series and wherein the two DC-DC stages are connected there to the same capacitive midpoint of the intermediate circuit side, wherein each DC-DC stage is set up to generate a time-variable output voltage by means of simultaneous switching when in operation, wherein their frequency lies between the grid frequency and three times the grid frequency.

2. Transformerless on-board charging device according to claim 1, wherein the at least two switching elements of the individual DC-DC stage are designed as transistors.

3. Transformerless on-board charging device according to claim 1, wherein the external switching element of the at least two switching elements of the individual DC-DC stage is designed as a transistor and the interior switching element of the at least two switching elements is designed as a diode.

4. Transformerless on-board charging device according to claim 1, wherein the switching elements have GaN-based transistors or SiC-based MOS field effect transistors (MOSFET) or Si-based MOS field effect transistors (MOSFET) or Si-based insulated gate bipolar transistors (IGBT).

5. Transformerless on-board charging device according to claim 1, wherein at least one of the two DC-DC stages is set up to adjust, while in operation, the phase angle of its time-variable output voltage in such a manner that it is in antiphase with the low-frequency oscillating medium potential (V_{M}), wherein the frequency of the time-variable output voltage lies between the grid frequency and three times the grid frequency.

6. Transformerless on-board charging device according to claim 1, wherein at least one of the two DC-DC stages is set up, while in operation, to adjust the amplitude of its time-variable output voltage in such a manner that it corresponds to the amplitude of the low-frequency oscillating medium potential (V_{M}), and thus ensures a constant battery terminal potential (V_{Batt,p} and/or V_{Batt,n}), wherein the frequency of the time-variable output voltage lies between the grid frequency and three time the grid frequency.

7. Transformerless on-board charging device according to claim 1, wherein the transformerless on-board charging device also has a controller, which is set up, while in operation, to provide at least one of the DC-DC stages for the matching time-variable output voltage and thereby inherently ensure at least a constant battery terminal potential (I_{Batt,p} and/or V_{Batt,n}).

8. Transformerless on-board charging device according to claim 7, wherein the controller is constructed in a cascade structure and is set up, while in operation, to regulate in the superordinate control circuit the battery terminal potential V_{Batt,p} and/or V_{Batt,n} to a constant target value (preferably: V_{Batt,p}=+U_{Batt}/2, V_{Batt,n}=−U_{Batt}/2), while the time-variable inductive current of the respective DC-DC stage can be regulated in the subordinate control circuit.

9. Transformerless on-board charging device according to claim 8, in which the neutral conductor or protective earth (PE), which is provided in the charging plug and in the vehicle-side connection interface as a signal contact, serves as reference potential for measuring the voltage of the respective battery terminal potential of the superordinate control circuit.

10. Transformerless on-board charging device according to claim 1, wherein the DC-DC stages of the transformerless on-board charging device have at least two inductor coils and on the battery side two capacitors, wherein there is provided in each case between the inductors of the DC-DC stages and the battery-side capacitors an additional switching element (S_{A1}, S_{A2}) to the capacitive midpoint of the intermediate circuit.

11. Method for controlling a DC-DC stage in a transformerless on-board charging device for electric vehicles according to claim 1, wherein the battery terminal potentials I_{Batt,p} and V_{Batt,n} are regulated to a constant target value ±U_{Batt}/2 so that the DC-DC-output voltages u_{DCDC,out,1}=U_{Batt}−u_{DCDC,out,2}, as well as the outputs, which vary over a grid period, of the DC-DC substages p_{DCDC,1} and p_{DCDC,2} are time-variable.

12. Transformerless on-board charging device for electric vehicles for the low-leakage-current charging of a traction battery BAT having a first DC-DC stage and a second DC-DC stage, wherein the two DC-DC stages are connected in series as a double stage, wherein the first DC-DC stage and the second DC-DC stage each have
at least two switching elements, in particular one transistor and one diode or two transistors,
at least one inductor coil, and
at least one output capacitor,
wherein both the first DC-DC stage as well as the second DC-DC stage are arranged symmetrically to a capacitive midpoint of an intermediate circuit, wherein in each case a DC-DC stage is connected to a partial intermediate circuit, wherein on the battery side the two DC-DC stages are connected in series and wherein the two DC-DC stages are connected there to the same capacitive midpoint of the intermediate circuit side, wherein each DC-DC stage is set up to generate a time-variable output voltage by means of simultaneous switching when in operation, wherein their frequency lies between the grid frequency and three times the grid frequency, wherein the at least two switching elements of the individual DC-DC stage are designed as transistors, wherein the external switching element of the at least two switching elements of the individual DC-DC stage is designed as a transistor and the interior switching element of the at least two switching elements is designed as a diode, wherein the switching elements have GaN-based transistors or SiC-based MOS field effect transistors (MOSFET) or Si-based MOS field effect transistors (MOSFET) or Si-based insulated gate bipolar transistors (IGBT), wherein at least one of the two DC-DC stages is set up to adjust, while in operation, the phase angle of its time-variable output voltage in such a manner that it is in antiphase with the low-frequency oscillating medium potential (V_{M}), wherein the frequency of the time-variable output voltage lies between the grid frequency and three times the grid frequency, wherein at least one of the two DC-DC stages is set up, while in operation, to adjust the amplitude of its time-variable output voltage in such a manner that it corresponds to the amplitude of the low-frequency oscillating medium potential (V_{M}), and thus ensures a constant battery terminal potential (V_{Batt,p} and/or V_{Batt,n}), wherein the frequency of the time-variable output voltage lies between the grid frequency and three time the grid frequency, wherein the transformerless on-board charging device also has a controller, which is set up, while in operation, to provide at least one of the DC-DC stages for the matching time-variable output voltage and thereby inherently ensure at least a constant battery terminal potential (V_{Batt,p} and/or V_{Batt,n}), wherein the controller is constructed in a cascade structure and is set up, while in operation, to regulate in the superordinate control circuit the battery terminal potential V_{Batt,p} and/or V_{Batt,n} to a constant target value (preferably: V_{Batt,p}=+U_{Batt}/2, V_{Batt,n}=−U_{Batt}/2), while the time-variable inductive current of the respective DC-DC stage can be regulated in the subordinate control circuit, wherein the DC-DC stages of the transformerless on-board charging device have at least two inductor coils and on the battery side two capacitors, wherein there is provided in each case between the inductors of the DC-DC stages and the battery-side capacitors an additional switching element (S_{A1}, S_{A2}) to the capacitive midpoint of the intermediate circuit, and wherein the neutral conductor or protective earth (PE), which is provided in the charging plug and in the vehicle-side connection interface as a signal contact, serves as reference potential for measuring the voltage of the respective battery terminal potential of the superordinate control circuit.
